(19) United States
(12) Patent Application Publication
(10) Pub. No.: US 2004/0107256 A1
(43) Pub. Date: Jun. 3, 2004

(54) Collaboration integration

(76) Inventors: Thomas Odenwald, Redwood City, CA (US); Slava Mikerin, Pacifica, CA (US)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/308,876

(22) Filed: Dec. 2, 2002

(51) Int. Cl. G06F 15/16; H04L 12/16; H04Q 11/00

(52) U.S. Cl. 709/205; 709/204; 370/260

(57) ABSTRACT

Integrating collaboration products or processes includes receiving a first collaboration request from a user application, selecting from among multiple available collaboration services offered by multiple service providers a first collaboration service from a first service provider that corresponds to the received first collaboration request, and providing the user application with session launch information that enables the user application to start a collaboration session using the first collaboration service from the first service provider.

### BACKGROUND

The following description relates to integration of multiple on-line collaboration tools and services.

Many collaboration tools exist today to help computer users communicate with other users in different locations in an efficient manner. For example, network meeting applications provide a virtual space in which to hold real-time, synchronous meetings. Such applications can offer live presentations or other objects for meeting participants to review and edit, instant messaging (IM), chat services for communications among the participants, and whiteboards on which participants can provide input. Network meeting applications can also provide, or be integrated with, teleconferencing or video teleconferencing services. These applications include WebEx Lotus Sametime Centra CentraOne, and Placeware Conference Center. Other collaboration applications may provide asynchronous interaction. For example, group members may interact using e-mail or other messaging options, and a collaboration area may be provided where members can review, annotate, comment on, and edit documents.

In general, different collaboration applications can provide users with different benefits. In some situations, one application is appropriate, while in others, a different application may be. It is unlikely, however, that any single company will provide the best-of-breed application in all of the areas that will interest a typical user. As a result, users may be required to establish a number of accounts, learn a number of interfaces for establishing collaboration sessions, and separately schedule and track various sessions.

### SUMMARY

This document discloses a method and system that assists in integrating the services provided by various collaboration tools or applications. In one aspect, a computer-implemented method of providing access to one or more collaboration services, is provided. In the method, a first collaboration request is received from a user application, a first collaboration service from a first service provider that corresponds to the collaboration request is selected from among a plurality of available collaboration services offered by a plurality of service providers, and the user application is provided with session launch information that enables the user application to start a collaboration session using the first collaboration service from the first service provider. The first collaboration service may be a member of a group of collaboration services for which the user application is approved, which may be a subset of the plurality of available collaboration services, and which may be determined by a user role associated with the user application. The collaboration request may also contain a list of proposed collaboration session participants, and the group of collaboration services may be a subset of the available services for which all of the participants are approved. The session launch information may contain a URL address that is distinct from the first service provider, and may be stored in a calendar associated with the user application.

A second collaboration request may be received from the user application, a second collaboration service from a second service provider may be selected from among a plurality of available collaboration service offered by a plurality of service providers, and the user application may be provided with session launch information that enables the user application to start a collaboration session using the second collaboration service from the second service provider. The first collaboration session occurs concurrently with the second collaboration session, and may be presented in a first view of a portal system, while the second collaboration session is presented in a second view.

A session launch request, which may correspond to the session launch information and may comprise a URL address that is distinct from the first service provider, may also be received from the user application, which may be directed to the first service provider to start the collaboration session. The user application may comprise a portal view, and the portal view may be directed to the first service provider. It may also comprise an instance of a web browser, which is directed to the first service provider. Information may also be received that relates to the collaboration session, such as from the service provider at the end of the collaboration session. The information may include the start time of the session, the stop time of the session, and a list of participants in the session, and the cost of the collaboration may be assigned to a group associated with the user application. The information may also contain a transcript from the collaboration session. A report on the collaboration session using historical data relating to the collaboration session may also be prepared.

A collaboration integration system is also disclosed, and comprises a plurality of service provider connectors, with each connector adapted to communicate information regarding collaboration sessions with a collaboration service provider using a protocol supported by the collaboration service provider. The system also comprises a client interface that receives messages from and transmits messages to a user application at a client remote from the system and an integration system configured to receive collaboration session requests from the client through the client interface, and direct the client to one of a plurality of collaboration service providers to establish a collaboration session. The client interface may deliver messages according to the HTTP protocol, and the integration system may be configured to receive a URL and send information stored at the URL location to the client through the client interface.

A data repository may also be provided to store information relating to a collaboration session, such as data representing the start and end times of a collaboration session. The repository may also be in communication with an enterprise resource planning system.

Advantageously, the method and system may provide effective integration for a user across a heterogeneous mix of collaboration service providers. In addition, a user may be provided with the ability to schedule and manage various collaboration sessions from a single calendar or scheduling applications.

Details of one or more implementations are set forth in the accompanying drawings and the description below. Other features and advantages may be apparent from the description and drawings, and from the claims.

### DRAWING DESCRIPTIONS

These and other aspects will now be described in detail with reference to the following drawings.

FIG. 1 is a block diagram of a system for managing communications between a computer user and a variety of collaboration services.

FIG. 2 is a block diagram of an integration system.

FIG. 3 is a flowchart of a process for establishing a collaboration session.

FIG. 4 is a flowchart of a process for starting a collaboration session.

FIG. 5 is a flowchart of a process for joining a collaboration session that has been started.

FIG. 6 is an interaction diagram showing steps that may be performed to start a collaboration session.

FIG. 7 is an interaction diagram showing steps that may be performed to join a scheduled collaboration session.

FIG. 8 is an interaction diagram showing steps that may be performed to start an instant collaboration session.

FIG. 9 is an interaction diagram showing steps that may be performed to start a scheduled collaboration session.

Like reference symbols in the various drawings indicate like elements.

### DETAILED DESCRIPTION

The systems and techniques described here relate to enabling a computer user or users to establish a collaboration session through a number of different collaboration services.

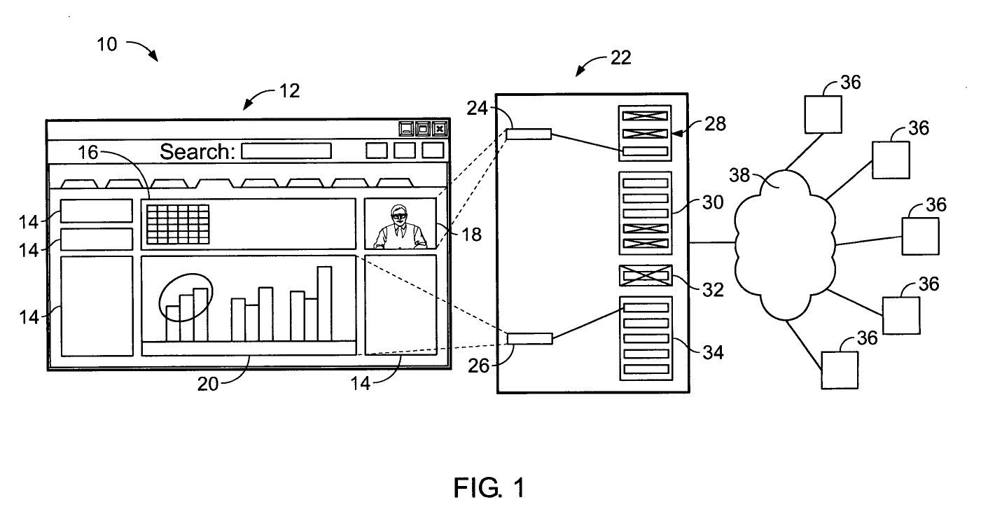

FIG. 1 is a block diagram of a system 10 for managing communications between a computer user and a variety of collaboration services. In the pictured example, the computer user interacts with system 10 through a portal 12. Portal 12 is a central interface that provides the user with access to various resources and information, including information that is stored in different formats on different computer systems. In addition, the portal 12 may provide updated information in real-time or near real-time, so that as the underlying data changes, the information displayed in portal 12 also changes. Portal 12 provides this information through various integrated views (also known as “iViews”) 14-26. These views can display information from enterprise resource planning (ERP) applications, customer resource management (CRM) applications, supplier resource management (SRM) applications, corporate Intranets, corporate workflow applications, business-to-business (B2B) commerce applications, the Internet, or Groupware applications (such as Microsoft Outlook or Lotus Domino), among other applications.

Portal 12 can be configured to show a variety of views. For example, general views 14 can show updated information regarding industry-specific news headlines, e-mail messages, stock prices, or current sales volume in a business, among other things. In addition, some views can be used to show information relating to a collaboration session, such as an e-meeting. For example, calendar view 16 shows a calendar along with information relating to the user's schedule. Using the calendar view 16, the user may select a date and time to set up a proposed collaboration session with one or more other users. Calendar view 16 may directly access schedule information stored by a standard calendar tool employed by the user, such as Microsoft Exchange or Lotus Domino. Alternatively, view 16 may provide an area to present a calendar generated by the user's calendar tool. As such, calendar view 16 can serve as a central scheduling tool for the user, or can also serve as an alternative scheduling tool that allows the user to keep a single, common schedule. The manner in which a user may schedule a collaboration session is described in more detail below.

Other views may be used to present one or more collaboration sessions, or sessions in which participants can interact with each other synchronously. For example, teleconference view 18 shows video of another user, and portal 12 may also provide corresponding audio. Likewise, presentation view 20 shows a presentation or document that may reside on the user's system or elsewhere, and that may be viewed and annotated by other users in a collaboration session. Teleconference view 18 and presentation view 20 may provide any of a number of features commonly used with electronic meeting and teleconferencing applications. Other collaboration sessions may involve instant messaging, chat, desktop sharing, document sharing, and application sharing, among others.

The collaboration sessions, as represented by teleconference view 18 and presentation view 20, may be established with the assistance of integration system 22. Integration system 22 may serve as an intermediary that aids the communication between a user and a variety of collaboration providers 36. Advantageously, integration system 22 may relieve the user of the chore of locating an appropriate or best collaboration provider for a particular situation. In addition, integration system 22 may control access for the user to particular collaboration providers 36. For example, a corporation or other enterprise may have established relationships with particular collaboration providers 36, and integration system 22 may be configured so that employees of the corporation may only use those collaboration providers 36. Certain users may be given access to particular providers while other users are given access to different or additional providers. Such discrimination and control may be beneficial, for example, where a company wants to provide certain employees with limited chat capabilities, but wants to provide other users, such as engineers working on a high-priority project, with greater capabilities, such as full real-time document sharing capabilities and access to electronic collaboration rooms. Moreover, where a first company has entered into a joint development project with another company that uses collaboration services that are not normally used by the first company, integration system 22 may be used to give such special access to these other applications to all members of the joint development team, including those affiliated with the first company. In addition, integration system 22 may track information regarding collaboration sessions, such as the collaboration provider and the beginning and ending time of the session, so that the cost of the session may be assigned to a particular user (whether internal to one company or across several companies). Furthermore, integration system 22 may provide a user with a single access point for scheduling and managing various collaboration sessions, regardless of the identity and particular requirements of the provider. Additionally, one of the service providers may be a service provider operated by the user's own organization, so that collaboration sessions that are entirely internal to the organization can be operated internally, while sessions that involve people outside the organization could use third-party service providers. Other advantages will become apparent upon reading the following description.

As pictured, integration system 22 may provide a variety of connector groups 28-34 configured for communicating with collaboration providers 36. Each connector group may include a number of connectors for providing a certain type of collaboration service, such as video teleconferencing. The connectors in each group may be software modules that are written to interface the operation of a certain provider to integration system 22. For example, a standard API may be circulated for integration system 22, and a service provider wishing to offers its services to user of integration engine 22 may author a connector to meet the requirements of the API. The connectors translate commands from integration system 22 into whatever format is expected by the particular service provider.

For example, connector group 28 may contain connectors for communicating with collaboration providers that offer teleconferencing services. Likewise, connector group 34 may contain connectors for communicating with collaboration providers that offer presentation sharing services. Although the connector groups are shown as distinct groups for illustrative purposes, integration system 22 may represent the applications available from various providers in any of a number of ways. For example, a particular service provider could author a single connector that would operate with more than one collaboration service offered by the provider.

Integration system 22 also receives collaboration scheduling requests and other information from portal 12, and may provide portal 12 with information about the status of a session or sessions. In this manner, portal 12 serves as a client application for integration system 22. For example, a user may employ portal 12 to make a meeting request, such as by using calendar view 16. Portal 12 may cause information regarding the meeting request to be transmitted to integration system 22. This information may include, for example, the beginning and ending times of the meeting or session, the expected participants, and the types of services or applications to be made available during the session. Using this information, integration system may generate a session record 24, 26 that is then associated with portal 12 and one of more collaboration providers 36 and related collaboration provider connectors.

As an example, a user may seek to establish a video teleconference session and document sharing meeting with one or more other users, and integration system 22 may establish session record 24 to record information about the teleconference. The user may use the portal to access the data in his or her standard scheduling application, and may select to schedule a collaboration session. Integration engine 22 may save the information in session record 24, and may transmit a message to the user's application so that that a link to the integration is formed in the session schedule. The user may then select the link when it is time for the session, so as to send a signal to integration system 22 that causes a message to be sent to the service provider or providers to start the session.

The selection of particular connectors may be controlled by pre-established rules. Thus, as shown in FIG. 1, the user may be blocked from obtaining teleconferencing services from two providers (as shown by “X's” through their connector boxes) that would otherwise be available through integration system 22. The user may also be allowed to use any of the available providers in a group, as shown by connector group 34, which represents connectors to providers of chat applications. In such a situation, a priority rule may be used to provide the user with a default provider, and the user may then be given the opportunity to override the default and select a different provider. Also, as shown by connector group 32, an entire group or class of applications may be blocked from a user. For example, a low-level employee may be denied access to expensive teleconferencing service. Finally, some providers may be blocked while more than one are still allowed, as shown by connector group 30. In such a situation, one of the available providers may be assigned by default, and the user may be given the opportunity to override the default.

The providers to which a user will be given access—the providers available to the user—may be determined in a variety of ways. For example, as noted above, the providers may be only those providers with which the user or the user's employer has contracted. They could also be a subset of the providers with which the employer has contracted, as limited by the particular role played by the user. In addition, the available providers may also be determined as the common set of providers that are available to all the participants that have been selected for a particular meeting or session.

Integration system 22 can also provide authentication information regarding a user to a service provider. For example, some service providers may require user account information and passwords before a user can access the providers' applications. Integration system 22 may access such information that is stored for the user (such as in a corporate information system) and pass the information to the service provider for the user.

The configuration of integration system 22 may take a variety of forms. For example, although session records 24, 26 are shown separately for illustrative purposes, a single record could be used to schedule multiple different services from multiple different providers. Moreover, although the connection between portal 12 and a client is shown as a direct connection, and the connection with service providers 36 is shown as a connection through the Internet 38, the communications could flow via any number of paths. For instance, all of the messages could flow over the Internet or another public or private network, with some directed between integration system 22 and the user using portal 12, some between integration system 22 and service providers 36, and some directly between the user using portal 12 and one or more of service providers 36.

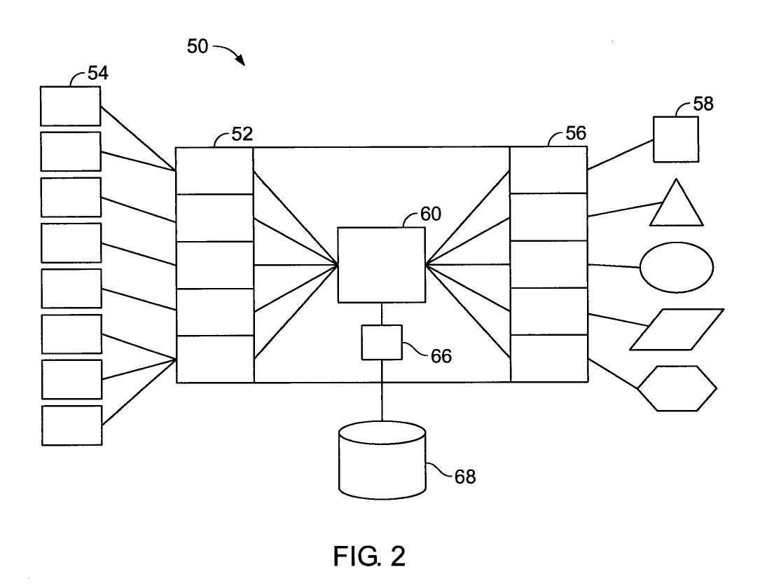

FIG. 2 shows a block diagram of an integration system 50, which communicates with other applications through client connectors 52 and service provider connectors 56. Clients 54 may be any of a number of different users of collaboration services, such as individuals or employees in a company or other enterprise. Clients 54 may also come from various organizations and access one or more integration systems 50. Service providers 58 can be any of a number of sources of collaboration products or services.

Integration system 50 is managed by a session controller 60, which sends information to, and receives information from, client connectors 52 and provider connectors 56. For example, session controller 60 may receive a meeting request from a user through a client connector and may then interact with the user to allow the user to select available applications (such as videoconferencing and chat) for the session, and service providers for the applications. Using the client connector, session controller 60 may translate the information received from the user into a format that can be recognized by a particular service provider 58 so as to notify the service provider that a meeting has been requested. Session controller 60 may also interface with other participants in the meeting and may update the appropriate service provider 58 and the remaining participants about the status of each other participant. Alternatively, such updates may take place directly between service provider 58 and the various participants, and session controller 60 may then be updated with appropriate information regarding the meeting or session.

Session controller 60 can save information about various sessions in repository 68 using repository interface 66. For example, session controller 60 can save information about expected meetings so that users can access the information and review it or make changes to it. Also, once a meeting has started or after it has ended, session controller 60 can save various history information regarding the meeting for later use.

As one example, session controller 60 can save information regarding the start and end times of a meeting, along with the meeting host and participants, to a structured data storage location, such as a business warehouse. That information may then be used and accessed by other applications, such as a use allocation application that invoices the user or the user's group for the use of a particular collaboration service. For example, a large corporation may have a fixed-rate agreement with various service providers, and the stored information may be used to allow the corporation to allocate the cost of its collaboration services across its various divisions or departments. Other examples of information that may be saved include: session start and end dates and times, session subject, session invitation text, session host and participants, the session service provider, and resources (such as documents, presentations, chat transcripts, or web sites visited) used or created during the session.

Other, less structured data about a session may also be stored. For example, chat logs, video or audio records, or various document or presentation edits may be saved during or at the close of a session. For example, the transcript of a design meeting (whether from a chat application or a voice recognition transformed recording of the session) could be stored in a knowledge management system so that members of the design group may later access the information, such as through a search engine. Workflow rules could also be applied to saved information. As an example, a document that is edited during a session may be routed for final approval to the various participants of the meeting, and may also be routed for approval to those who were invited to the meeting but did not attend, or to others who were not even invited (such as supervisors).

Session controller 60 may be configured so as to permit each client 54 to schedule and manage collaboration sessions using a single application. For example, a user of client 54 may use a standard calendar application, or a portal that displays a calendar application, to schedule collaboration sessions. The portal or calendar application may transmit a message or messages to session controller 60 containing information regarding the expected start and end times of the session, along with the expected participants. Session controller 60 may then return a message that causes the calendar application or portal to attach a session identifier, such as a hypertext link directed toward session controller 60, to the calendar for the client. When the time for the session arrives, the portal or calendar application may send a message to session controller 60 to cause session controller 60 to start the session. For example, the user may click on a hyperlink to cause an HTTP-formatted message to be sent to session controller 60, which will then access an associated session record in repository 68. Session controller may then use the information in the record to cause a collaboration session to begin between client 54 and one or more service providers 58, such as by redirecting an application at client 54 toward the one or more service providers. Changes to collaboration sessions can be made in a similar manner, so that session controller 60 stays in synchronization with the schedule stored locally at client 54. In this manner, a user can continue to use his or her preferred scheduling application to establish sessions with multiple different collaboration service providers 58. In addition, a user may be able to establish a collaboration session that uses services from multiple service providers 58 using a single calendar entry.

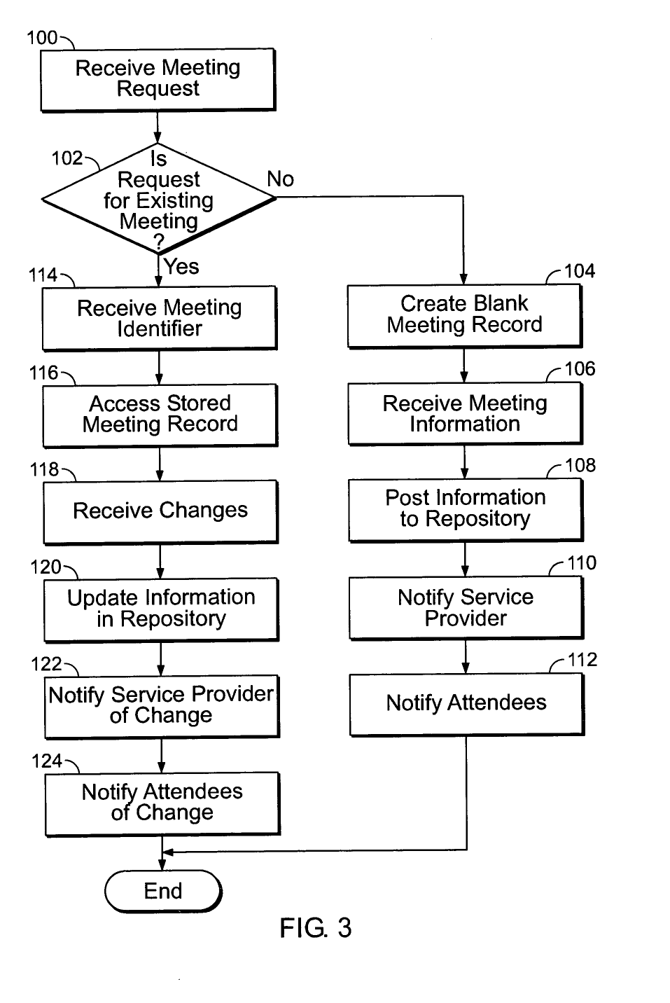

FIG. 3 is a flowchart of a process for establishing a collaboration session. At block 100, a system receives a request from a user regarding a collaborative session. If the request does not relate to any meeting that has yet been established, as determined at block 102, the system creates a blank session record at block 104. This session record can include fields for various parameters relating to a session, as discussed above. The system may then, at block 106, receive information from the user or elsewhere regarding the session to be established. Once the system has received the appropriate information, which may be indicated by the user clicking on a submission button, and may be provided to the system concurrently with the session request, the information may be posted to the repository as indicated by block 108. In addition, the system may also notify the service provider (block 110) and any selected attendees (block 112) of the session. In addition, such a notice may be provided by the first user or by the service provider. The system may also access a database of available providers so as to choose a particular provider for the user, provide the user with a list of available providers, or inform the user that a selected provider is not available to the user. The session request may also indicate that an instant session, rather than a scheduled session, is desired, so that the session is begun immediately upon establishing the session.

If a meeting has already been established, the system may seek and receive an identifier, at block 114, regarding the meeting that the user would like to review. This identifier may be provided, for example, by the user directly or by information sent from the user's application, such as by a URL identifier that the user has selected. At block 116, the system accesses the stored meeting record so that the meeting information may be displayed to the user. Upon reviewing the information, the user may make changes, as shown at block 118, such as by rescheduling the session or adding or removing invitees. Once the changes are complete, the information in the repository may be updated (block 120), and the service provider (block 122) and attendees (block 124) may be notified. In addition, the system may send information to the user to update the user's schedule with the new session information. The system may also notify the user of any changes in provider that are required from the changes the user has made. For example, if the user has added a participant that cannot use a particular provider, the system can change providers for the session or can give the user an option to select a new provider. As one example, if the meeting previously included only participants who worked for a single company, the company's own network may have been assigned to provide the collaboration services, while if a participant from another company is added, a third-party service provider may be needed.

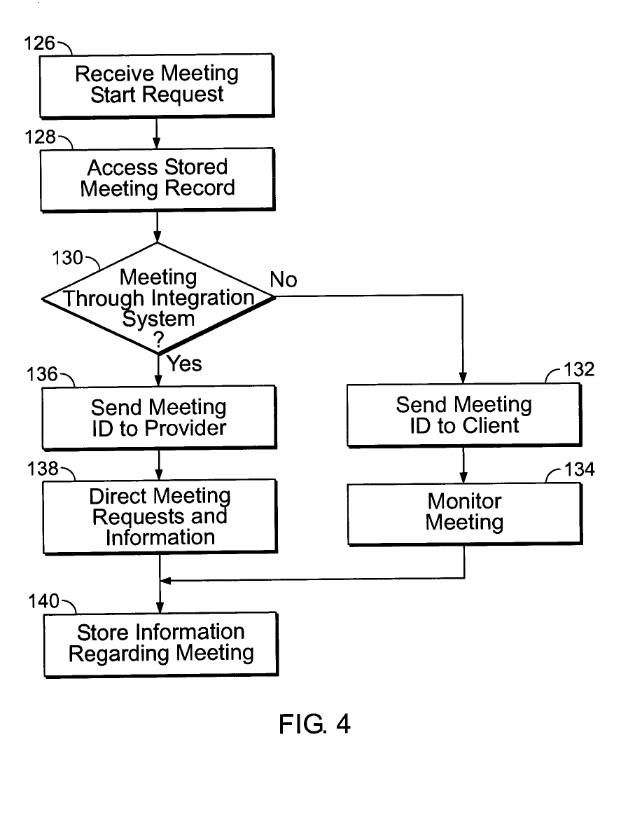

FIG. 4 is a flowchart of a process for starting a collaboration session, such as a session that has previously been scheduled. At block 126, the system first receives a session start request. This request may be generated, for example, in response to a user's clicking on a hyperlink to start a meeting, or automatically at a preset time by the user's system, by a service provider, or by the integration system. Other information about the session may then be accessed from the stored session record (block 128). The session may then be initiated with the service provider, either directly by the integration system or by the user's system (as determined at block 130). Where the session is initiated through the integration system, the integration system may send a session identifier to the service provider (block 136), and may subsequently receive communications regarding the session and redirect them either to the service provider or to participants in the session (block 138). The integration system may also take a more passive role, and may send identifying information regarding the session to the client system used by the user (block 132), which may in turn forward the information to the service provider. For example, the integration system may send an HTTP-formatted signal or signals to the client to redirect a web browser or other application, such as a view in a portal, to the service provider, and also provide the client with the appropriate identification and authentication information. In such a situation, the communication may occur between the various users and the service provider, as if the integration system were absent. However, certain information regarding the session may be intercepted by, or directed to, the integration system (block 134). The information may also be sent to the integration system when the session is complete, along with additional information, such as transcripts, audio files, and video files from the sessions. This information may then be stored in the repository (block 140) or another appropriate data store or data stores. For example, the start and end times of the session, along with identifier for each session participant, may be stored. Also, more complex information, such as copies of documents that were shared during the session, may also be stored. In one example, the service provider may send a signal and additional information to the integration system at the close of the collaboration session or at some other point in time.

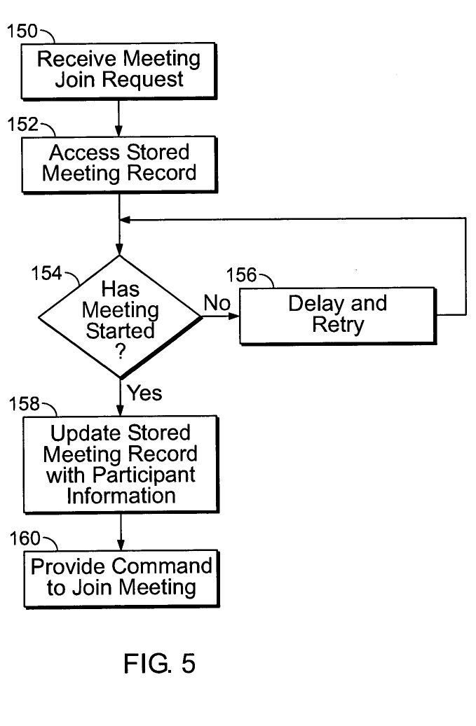

FIG. 5 is a flowchart of a process for joining a collaboration session that already has been started. This process may apply, for example, to users who have been invited to participate in a session. At block 150, the system receives a request to add a participant to the meeting. The stored session record may be accessed (block 152) to determine the rights of the particular user with respect to the session (e.g., whether the user has been invited). If the session has not yet been initiated (as tested by block 154), the system may delay the user until the meeting has been started (block 156). For example, the system may periodically re-send requests to the service provider regarding the session. Alternatively, the collaboration application may be configured to transmit an alert signal so as to cause the computer system of the user who is waiting to generate an alert and to launch the session. This alert signal may be triggered by a signal from the collaboration service provider. As an option, the system may provide the user with a diversion, such as a puzzle, a simple videogame, music, or other audio to keep the user interested and occupied while waiting for the session to begin. Also, the system might connect the user to the collaboration provider (such as by redirecting the user's application to the provider with an appropriate message and authorization/identification information) and allow the provider to hold the user until the session begins.

If the session has started, the system may update the stored record with information regarding the new user (block 158), and the service provider may then be provided with a command to add the user to the session (block 160), either from the integration system or from the user's system, such as by the integration system redirecting the user's application to the service provider, as described above.

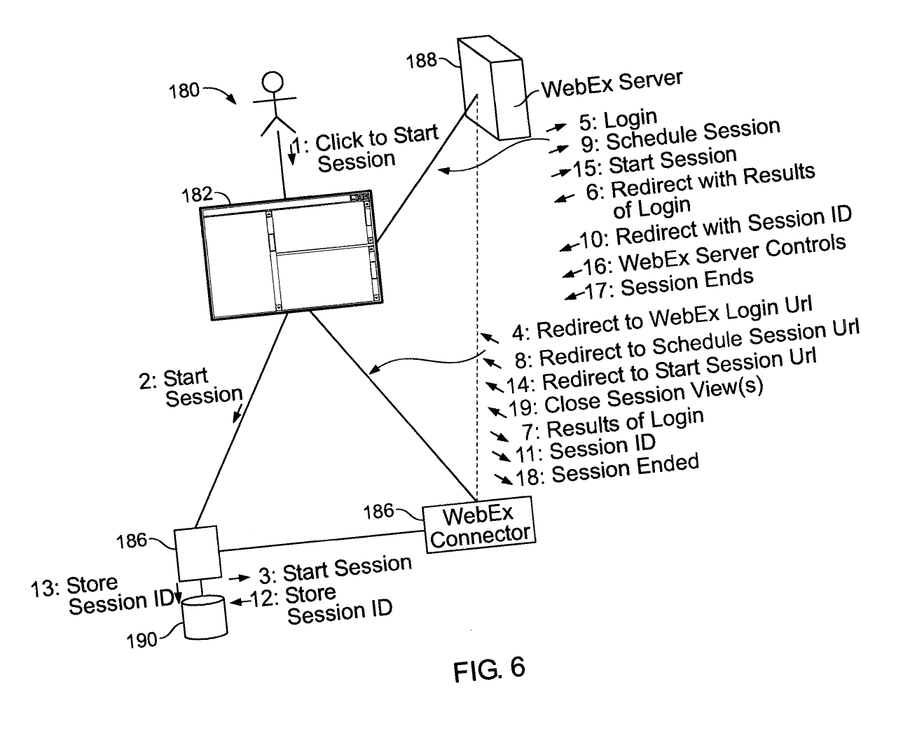

FIG. 6 is an interaction diagram that shows steps that may be performed to start a collaboration session. The figure shows various parts of a collaboration system with communication links between them, with numbered and described arrows that show, in general, the order in which particular actions may be taken, and the actors connected by the actions. For example, in FIG. 6, user 180 provides his or her user application 182 with a command to start a session, and the user application 182 forwards the request (either as it was sent or after transforming it) to integration system 184. The command may be, for example, a manual clicking on a link in a schedule entry, or it could be generated automatically be the user's scheduling application. The link may be a URL address at integration system 184, that was previously sent from integration system 184 to user application 182 when the session was scheduled. Alternatively, the schedule may be kept by integration system 184, so that integration system 184 starts the process (such as by sending a signal to user application 182 so that it alerts the user 180 of the impending session and seeks a response from the user 180). In one embodiment, user application 182 may be a browser and may communicate using HTTP messaging. Alternatively, user application 182 may be a portal or an application that interacts with a portal and may treat integration system 184 as a general web service. Other configurations may also be used.

Integration system 184 then causes service connector 186 to send a redirection signal to browser 182, which may in turn cause browser 182 to log into service provider 188, which in this example is a WebEx application. Results of the login may be returned to service connector 186 via user application 182, and meeting scheduling also may occur between service connector 186 and service provider 188, through user application 182 in a similar manner. With the schedule set, a session ID may be issued by service provider 188 and stored in repository 190. Once the session is started, control may be transferred to the service provider 188 until the session ends, at which point additional information may be stored in repository 190 after being received from user application 182 or service provider 188. In addition, service connector 186 may monitor the progress of the session and may capture or produce information about the session that can be accessed later.

Additional collaboration sessions may also be established concurrently with the first collaboration session so that they have partial or complete time-wise overlap. For example, user 180 may schedule multiple services from different vendors for a single session. In addition, user 180 may choose to have multiple sessions operating at the same time, so as to perform multiple jobs at the same time.

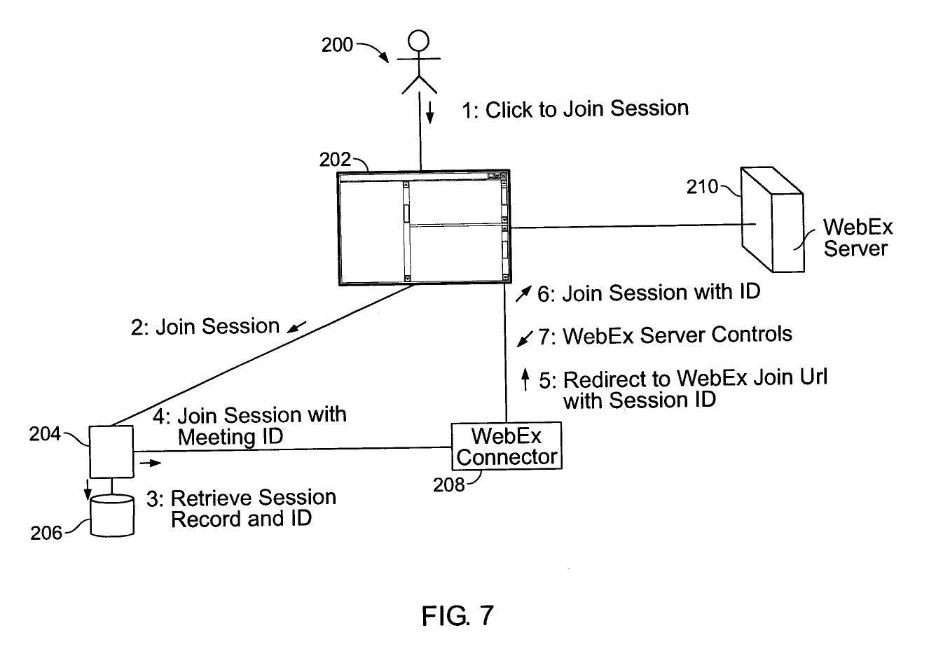

FIG. 7 is an interaction diagram that shows steps that may be performed to join a scheduled collaboration session. User 200 may initially click (such as on a URL link) to join a session, and user application 202 may forward the request to integration system 204, which may in turn retrieve information about the session from repository 206. Integration system 204 may then send a signal to service connector 208 so as to redirect user application 202 to the appropriate service provider 210—here again, a WebEx server—that then controls further interaction with the new user. Again, service connector 208 may monitor the session to obtain or create information about it. In addition, service connector 208 and/or integration system may receive information about the session, such as from service provider 210.

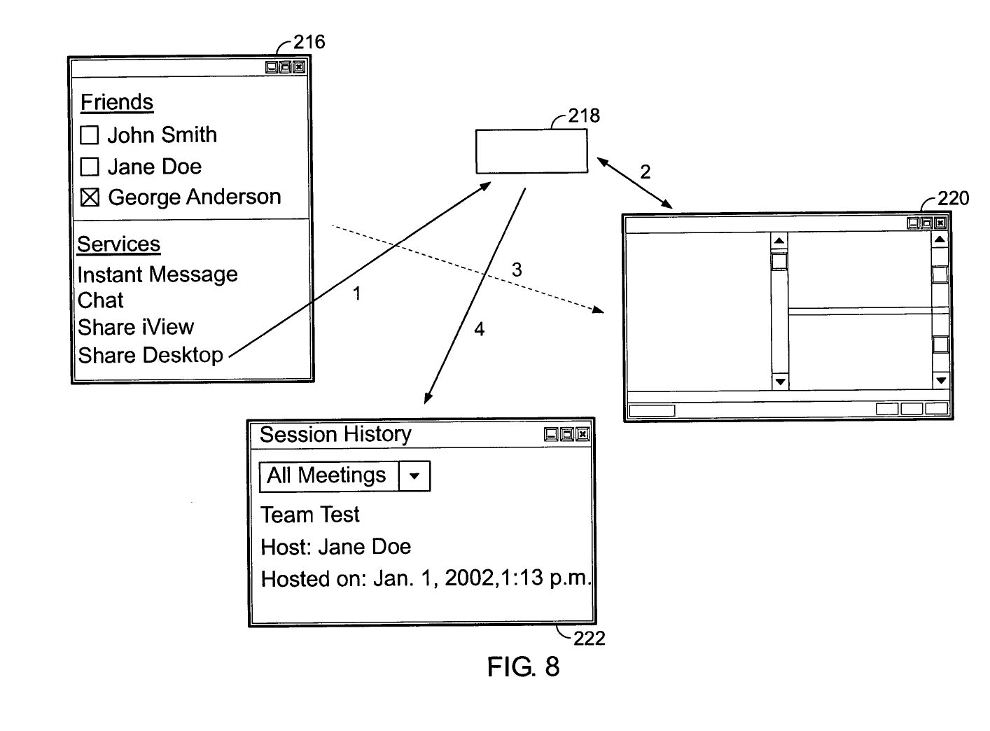

FIG. 8 is an interaction diagram that shows views that a user may be presented with in connection with steps performed to start an instant collaboration session. As shown, a view 216 from a portal may show various potential participants for a collaboration session, and may also provide a number of collaboration services to be used, such that clicking on one of the services will automatically launch the service. The selection of the service in view 216 is communicated to integration system 218, which then informs a service provider (such as by establishing session information and passing the information to the provider by redirecting the user's application), and hands over control of the session to the service provider, as shown by view 220. At an appropriate point during or after the session, integration system 218 may provide information that it has collected from the session to various users of the system, such as by a collaboration report 222.

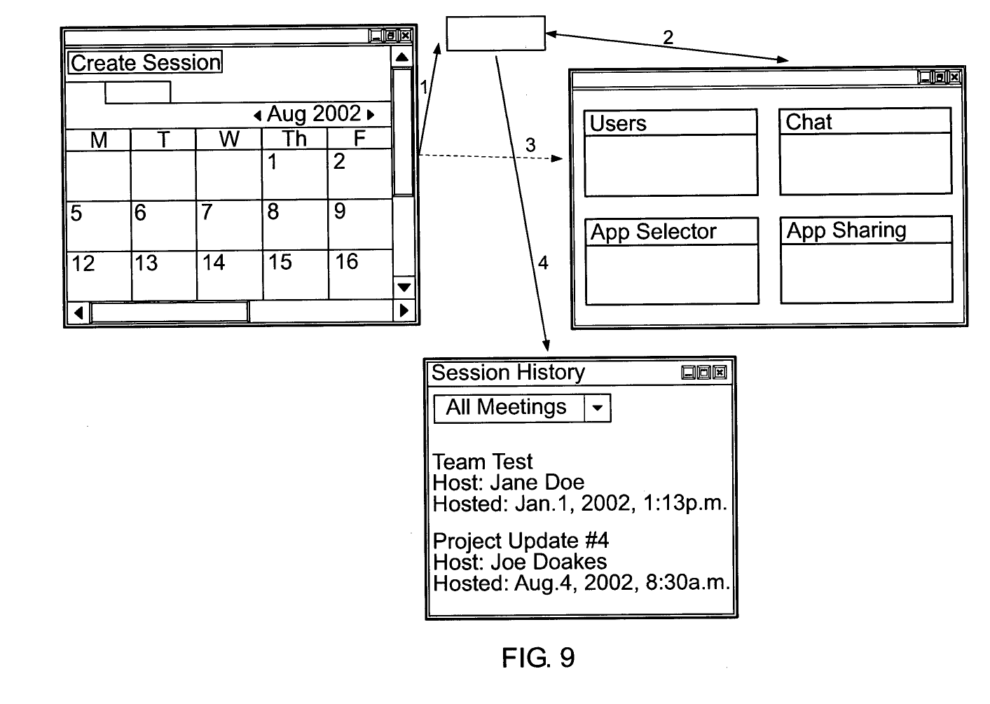

FIG. 9 is an interaction diagram that shows views that a user may be presented in connection with steps that are performed to start a scheduled collaboration session. This figure is similar to FIG. 8, but the calendar view 224 shows a calendar for scheduling a meeting rather than choices for an immediate meeting. The user's interaction with calendar view 224 may result in a message being sent to integration system 226 so that RTC application 228 is launched by a service provider at the scheduled time. Also at an appropriate time, integration system 226 may collect information regarding the established session and may provide such data to collaboration report 230.

As used herein, the terms “electronic document” and “document” mean a set of electronic data, including both electronic data stored in a file and electronic data received over a network. An electronic document does not necessarily correspond to a file. A document may be stored in a portion of a file that holds other documents, in a single file dedicated to the document in question, or in a set of coordinated files.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Although a few embodiments have been described in detail above, other modifications are possible. Portions of this disclosure discuss operation though a portal, but any of a number of access systems and methods may be used to manage collaboration sessions. The logic flows depicted in FIGS. 3-9 do not require the particular order shown, or sequential order, to achieve desirable results. Other embodiments may be within the scope of the following claims.

What is claimed is:

1. A computer-implemented method of providing access to one or more collaboration services, the method comprising:
receiving a collaboration request from an application;
selecting, from among a plurality of available collaboration services offered by a plurality of service providers, a first collaboration service from a first service provider, the selected collaboration service corresponding to the received collaboration request; and
providing the application with session launch information that enables the application to start a collaboration session using the first collaboration service from the first service provider.

2. The method of claim 1, wherein the first collaboration service comprises a member of a group of collaboration services for which the application is approved.

3. The method of claim 2, wherein the group of collaborations services comprises a subset of the plurality of available collaboration services.

4. The method of claim 2, wherein the group of collaboration services is determined by a user role associated with the user application.

5. The method of claim 2, wherein the collaboration request comprises a list of proposed collaboration session participants, and the group of collaboration services is a subset of the available services for which all of the participants are approved.

6. The method of claim 1, wherein providing the session launch information comprises providing a URL address that is not directed to the service provider.

7. The method of claim 6, wherein the session launch information is stored in a calendar associated with the application.

8. The method of claim 1, further comprising receiving a second collaboration request from the application;
selecting, from among the plurality of available collaboration service offered by the plurality of service providers, a second collaboration service from a second service provider that corresponds to the received second collaboration request; and
providing the application with session launch information that enables the application to start a collaboration session using the second collaboration service from the second service provider.

9. The method of 8, wherein the first collaboration session occurs concurrently with the second collaboration session.

10. The method of claim 9, wherein the first collaboration session is presented in a first view of a portal system, and the second collaboration session is presented in a second view of the portal system.

11. The method of claim 1, further comprising receiving a session launch request from the user application; and
directing the user application to the first service provider to start the collaboration session.

12. The method of claim 11, wherein the session launch request corresponds to the session launch information.

13. The method of claim 11, wherein the session launch request comprises a URL address that is distinct from the first service provider.

14. The method of claim 11, wherein the user application comprises a portal view, and the portal view is directed to the first service provider.

15. The method of claim 11, wherein the user application comprises an instance of a web browser, and the instance is directed to the first service provider.

16. The method of claim 11, further comprising receiving information related to the collaboration session.

17. The method of claim 16, wherein the information related to the collaboration session is received from the service provider.

18. The method of claim 16, wherein the information related to the collaboration session is received at the conclusion of the collaboration session.

19. The method of claim 17, wherein the information comprises the start time of the session, the stop time of the session, and a list of participants in the session.

20. The method of claim 19, further comprising assigning a cost of the collaboration session to a group associated with the user application.

21. The method of claim 18, wherein the information comprises a transcript from the collaboration session.

22. The method of claim 18, further comprising generating a report on the collaboration session using historical data relating to the collaboration session.

23. A collaboration integration system comprising:
a plurality of service provider connectors, each connector adapted to communicate information regarding collaboration sessions with a collaboration service provider;
a client interface that receives messages from and transmits messages to a user application at a client remote from the system; and
an integration system operative to receive collaboration session requests from the client through the client interface, and to direct the client to one of a plurality of collaboration service providers to establish a collaboration session.

24. The collaboration integration system of claim 23, wherein the client interface delivers messages according to the HTTP protocol.

25. The collaboration integration system of claim 24, wherein the integration system is further operative to receive a URL and send information stored at the URL location to the client through the client interface.

26. The collaboration system of claim 23, further comprising a data repository that stores information relating to a collaboration session.

27. The collaboration system of claim 26, wherein the data repository stores data representing the start and end times of a collaboration session.

28. The collaboration system of claim 27, wherein the repository is in communication with an enterprise resource planning system.
